(19) United States
(12) Patent Application Publication
(10) Pub. No.: US 2007/0007376 A1
(43) Pub. Date: Jan. 11, 2007

(54) Wear-resistant anvil and impact rock crusher machine using such wear-resistant anvil

(76) Inventors: Gary J. Condon, Irwin, PA (US); Timothy J. Diehl, Bedford, PA (US); Duane E. Carson JR., Hollidaysburg, PA (US); Don C. Rowlett, Bedford, PA (US); Kris E. Strothmann, Mt. Vernon, IL (US)

Correspondence Address: KENNAMETAL INC., P.O. BOX 231, 1600 TECHNOLOGY WAY, LATROBE, PA, 15650, US

(21) Appl. No.: 11/176,019

(22) Filed: Jul. 7, 2005

(51) Int. Cl. B02C 19/00

(52) U.S. Cl. 241/275

(57) ABSTRACT

An anvil that is for use in a rock crusher machine. The anvil presents a body that has an impingement surface, which has a high concentration wear area and a low concentration wear area. The anvil further includes a wear-resistant member. The high concentration wear area of the body has the wear-resistant member. The high concentration wear area of the body has a greater wear resistance than the low concentration wear area of the body.

### BACKGROUND OF THE INVENTION

The invention pertains to an anvil for use in an impact rock crusher machine wherein the rocks impinge against the anvil during the rock crushing process. In particular, the invention pertains to an improved anvil for use in an impact rock crusher machine wherein such anvil provides for an increased useful life as compared to earlier anvils.

Generally speaking, an impact rock crusher machine is utilized to reduce the size of larger earth materials (e.g., rocks) into aggregate of a smaller size. The construction industry trades employ a variety of impact crusher machines to reduce large aggregate to aggregate sizes and shapes required to satisfy construction specifications for mixtures and admixtures of aggregate with cement and other ingredients.

During the rock crushing process, an impact rock crusher machine receives aggregate, which is of a larger size, for crushing or reducing aggregate into a smaller size. The impact rock crusher machine feeds aggregate to an impeller table, which has a central feed body and impeller shoes attach to an impeller assembly. The impeller shoes, in combination with centrifugal force, hurl and direct a flow or stream of larger size aggregate against one or more anvils located within the crusher. This type of rock crusher machine is shown and described in published United States Patent Application No. US2004/0251358A1 to Condon, published on Dec. 13, 2004 (filed on Jun. 11, 2003, patent application Ser. No. 10/459,252), which is hereby incorporated by reference herein.

As mentioned in U.S. Pat. No. 6,033,791 to Smith et al., the anvils in a rock crusher machine experience substantial wear during the rock crusher operation due to the impingement of the aggregate thereon. An anvil experiences wear up to where it exceeds its useful life and it is then necessary to replace the anvil. In order to replace an anvil, the operator must stop the rock crusher machine so that he can detach the used anvil and replace it with a new anvil. This activity takes time away from the operation of the rock crusher machine. Hence, it would be desirable to provide an anvil that would reduce the number of times that the operator must stop operation of the rock crusher machine in order to replace the anvils. More specifically, it would be highly desirable to provide an anvil that presents better wear resistance, and hence, a longer useful life, than what has been heretofore available.

As mentioned above, in an impact rock crusher machine, rocks or aggregate are hurled again the anvil whereby the rocks breaks the aggregate into smaller size aggregate. The rock crusher machine maintains an optimum efficiency when the maximum (or optimum) amount of breakage of the aggregate occurs upon impingement of the aggregate against the anvil. Experience has shown that the efficiency of the rock crusher machine decreases as the anvil wears. This is due to the fact that an increase in the wear of the anvil results in a change in the geometry of the impingement surface (or face) such as, for example, from a flat surface into a cupped or concave-shaped surface. When the aggregate impacts the cupped surface, not as much aggregate is broken as compared to aggregate that impacts a flat surface. Hence, an increase in the anvil wear results in a decrease in the amount of breakage of the aggregate. Such a decrease in the amount of breakage of the aggregate requires that the unbroken aggregate be again hurled against the anvil.

It can be appreciated that the necessity to re-hurl (or re-process) the aggregate against the anvil increases the processing costs and the time required to break the aggregate to the desired size requirements. It would thus be highly desirable to provide an improved anvil for use in a rock crusher machine that exhibits improved wear resistance so as to maintain the flatness of the anvil face and the operational efficiency of the rock crushing process for a longer duration.

### SUMMARY OF THE INVENTION

In one form thereof, the invention is an anvil for use in a crusher. The anvil comprises a body that has an impingement surface wherein the impingement surface has a high concentration wear area and a low concentration wear area. The anvil further includes a wear-resistant member. The high concentration wear area of the body has the wear-resistant member and the high concentration wear area of the body has a greater wear resistance than the low concentration wear area of the body.

In another form thereof, the invention is an anvil for use in a crusher. The anvil comprises a body that has an impingement surface that has a greater impingement portion that experiences a greater extent of impingement. The body contains a plurality of wear-resistant members made from one or more wear-resistant materials. The greater impingement portion contains a higher concentration of the one or more wear-resistant materials.

In still another form thereof, the invention is an anvil for use in a crusher. The anvil comprises a body that has an impingement surface whereby aggregate impinges against the impingement surface. The body is positionable between a first position and a second position. A first portion of the impingement surface experiences a greater extent of impingement when the anvil is in the first position. A second portion of the impingement surface experiences a greater extent of impingement when the anvil is in the second position. The body contains wear-resistant material. The first portion of the impingement surface contains a higher concentration of the wear-resistant material, and the second portion of the impingement surface containing a higher concentration of the wear-resistant material.

### BRIEF DESCRIPTION OF THE DRAWINGS

The following is a brief description of the drawings that form a part of this patent application:

FIG. 1 is an isometric view of an impact rock crusher machine of the type employing a specific embodiment of the anvil of the present invention and wherein a portion of the housing is cut away so as to expose the impeller turntable and anvils;

FIG. 2 is an isometric view of a specific embodiment of an anvil from the impact crusher machine of FIG. 1 when the anvil is in an unworn condition and the top portion of the anvil is broken away to show the different depths the inserts extend into the body;

FIG. 3 is cross-sectional view of the anvil of FIG. 2 taken along section line 3-3 and shows the different depths that the wear-resistant inserts extend into the body;

FIG. 4 is an isometric view of the anvil of FIG. 2 when in a typical worn condition wherein the right hand side (as viewed in FIG. 4) experiences the greatest amount of wear and wear occurs between the inserts;

FIG. 5 is an isometric view of a second specific embodiment of an anvil for use in an impact rock crusher machine and shows that the exposed surfaces of the inserts are flush with the surface of the anvil body;

FIG. 6 is cross-sectional view of the anvil of FIG. 5 taken along section line 6-6 and shows that all of the inserts extend the same depth into the body;

FIG. 7 is an isometric view of another (third) specific embodiment of an anvil of the invention wherein the wear-resistant members (or inserts) are oriented so that the gaps there between do not extend completely across the horizontal dimension of the anvil;

FIG. 8 is a cross-sectional view of the anvil of FIG. 7 taken along section line 8-8 and shows two interior inserts extending into the body;

FIG. 9 is a cross-sectional view of the anvil of FIG. 7 taken along section line 9-9 and shows two exterior inserts extending into the body;

FIG. 10 is a cross-sectional view of the anvil of FIG. 7 taken along section line 10-10 and shows two interior inserts and two exterior inserts extending into the body; and

FIG. 11 is an isometric view of the upper portion of still another (fourth) specific embodiment of the anvil of the invention wherein the wear-resistant members present differing geometric shapes and orientations.

### DETAILED DESCRIPTION OF SPECIFIC EMBODIMENTS

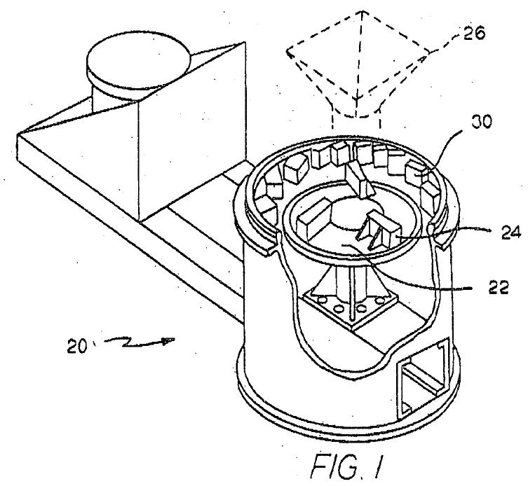

Referring to FIG. 1, a vertical shaft impeller rock crusher machine, which is generally designated as 20, includes an impeller turntable 22. The impeller turntable 22 revolves at a high speed about a central shaft (not illustrated). Impeller blade shoes 24 are fixed to the impeller turntable 22 at a regular interval (i.e., consistent spacing) along its surface. Rock or other aggregate (not illustrated) are fed from an overhead funnel 26 onto the impeller turntable 22 along the lines as shown and described in U.S. Pat. No. 6,601,789 to Bajadali et al., which is hereby incorporated by reference herein. Typically, the aggregate that is fed onto the impeller turntable 22 can be considered to be of a larger size.

The centrifugal force generated via the rotation of the impeller turntable 22 causes above the impeller shoes 24 slings or hurls the rock or aggregate in a radial outward direction so that it strikes (or impinges) upon the surface of one or more anvils 30. Typically, the anvils are oriented so that the impingement surface thereof is normal to the direction of movement of the aggregate hurled by the impellers. See U.S. Pat. No. 5,921,484 to Smith et al., which is hereby incorporated by reference herein. Upon impingement, the larger sized aggregate breaks apart into aggregate of a smaller size. In other words, the larger-sized aggregate is crushed into smaller-sized aggregate.

The impeller blades 24 and the central feed body are mounted to an impeller table by methods well known in the industry. Further, the anvils are mounted to the outer ring of the impact rock crusher machine in a manner known to those skilled in the art.

There is more than one way to mount the anvils to the rock crusher machine. In one arrangement, once one portion of the anvil becomes worn, the anvil can be rotated 180 degrees to expose another portion of the anvil to the impingement of the aggregate. U.S. Pat. No. 4,090,673 to Ackers et al. shows and describes such an arrangement. Applicants hereby incorporate U.S. Pat. No. 4,090,673 to Ackers et al. by reference herein. In another arrangement, to expose unworn surfaces, the anvils are adjusted in a radial inward direction toward the impeller assembly. U.S. Pat. No. 4,126,280 to Burk shows and describes such an assembly. Applicants hereby incorporate U.S. Pat. No. 4,126,280 to Burk by reference herein. In still another arrangement, the ring to which the anvil mounts can be raised or lowered in the vertical direction so as to expose different portions of the anvil to the impingement of the aggregate.

As can be appreciated, the impingement of rock (or aggregate) on the anvils causes the anvils to experience wear due to such impingement. Heretofore, in many commercial arrangements, the anvils have been made from a high chromium-iron alloy, which while satisfactory, has experienced wear. One exemplary iron alloy is a so-called white iron alloy that has a composition along the lines of ASTM Specification A532 class III A alloy (2.3-3.0 weight percent carbon; 0.5-1.5 weight percent manganese; up to 1.0 weight percent silicon; up to 1.5 weight percent nickel; up to 1.5 weight percent molybdenum; 23-28 weight percent chromium, trace impurities and the balance iron). Like for most wear products, there always exists a need to improve such a wear product through increasing the wear resistance thereof and the resultant useful life.

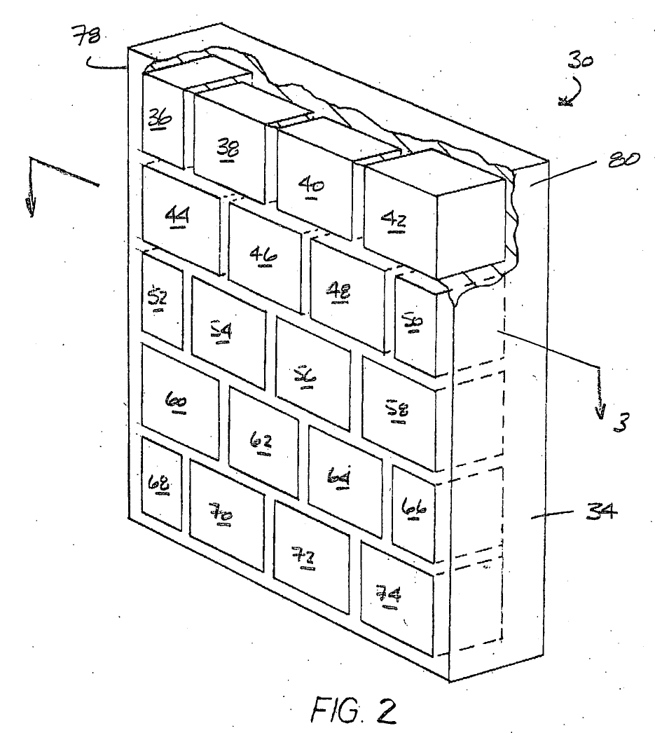

As described above, in some rock crusher machines the anvil is rotatable 180 degrees after it has experienced a certain degree of wear. This type of anvil is illustrated in FIGS. 1 and 2. More specifically, anvil 30 has an iron alloy (or steel) body 34 that contains a plurality of tungsten carbide inserts 36 through 74. These tungsten carbide inserts 36 through 74, which are cast in the steel body, are positioned in the steel body 34 so as to provide for optimal wear resistance. One preferred technique by which the anvil 30 can be made is shown and described in U.S. Pat. No. 4,608,318 to Makrides et al. In the Makrides et al. patent, hard inserts (e.g., tungsten carbide) are positioned within a mold and steel (or matrix material) is cast about the hard inserts. Applicants hereby incorporate U.S. Pat. No. 4,608,318 to Makrides et al. by reference herein.

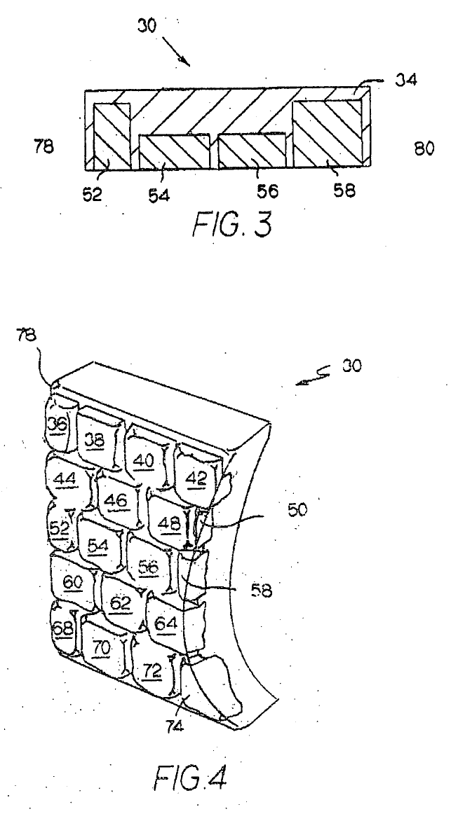

Referring to the tungsten carbide inserts 36 through 74, especially as illustrated in FIGS. 2 and 3, the tungsten carbide inserts located at (or near) the generally horizontal opposite horizontal edges (78 and 80) of the anvil 30 are of a different size (or can be oriented in different ways) so as to provide for better (or optimum) wear resistance than the interior tungsten carbide inserts located away from the horizontal edges 78 and 80 of the anvil 30. The exposed surface of each insert is flush with the surface of the body to form the impingement surface (or face). As shown in FIG. 3 and referring to the middle horizontal row of inserts, inserts 52 and 58 extend deeper into the steel body 34 than do interior inserts 54 and 56. It should be noted that wear-resistant inserts 52 and 54 are essentially the same insert, except that they are oriented in different ways. Insert 52 is oriented to extend deeper into the body and present a smaller area of exposed surface while insert 54 is oriented to extend shallower into the body and present a larger area of exposed surface.

Typically, the portion of the impingement surface that experiences the greater degree of wear will have a higher concentration of wear-resistant material in the form of the inserts. The portion of the impingement surface that experiences the lesser degree of wear will have a lower concentration of wear-resistant material in the form of the inserts.

Although not shown for the other inserts, this is also true for the other inserts. In this regard, inserts 36, 44, 60 (as well as 52) and 68 positioned along the left horizontal side 78 of the anvil typically are of a different size (or can be oriented in different ways) so as to provide for better (or optimum) wear resistance than the interior tungsten carbide inserts (38, 40, 46, 48, 54, 56, 62, 64, 70 and 72). In this regard, and in some cases inserts like 36, 44, 52 and 60 can be considered to have exposed a larger-sized wear-resistant portion of the member while the interior inserts can be considered to have exposed a smaller-sized wear-resistant portion of the member. The same is true for the inserts positioned at or near the right side 80 of the anvil wherein inserts 42, 50 (as well as 58), 66 and 74 are of a different size (or can be oriented in different ways) so as to provide for better (or optimum) wear resistance than the interior tungsten carbide inserts (38, 40, 46, 48, 54, 56, 62, 64, 70 and 72). It should be noted that insert 40 and insert 42 have substantially the same exposed surface area on the impingement surface, and yet, insert 42 extends deeper into the body of the anvil.

The area of the impingement surface that is along the left side of the anvil body can be considered to be a first portion of the impingement surface. The area of the impingement surface along the right side of the anvil body can be considered to be a second portion of the impingement surface. The interior area of the impingement surface that does not experience as great an extent of wear can be considered to be the third portion of the impingement surface.

The principal reason that these inserts 52 and 58 extend deeper into the body 34 is to better resist the greater extent of wear experienced along the opposite horizontal edges (or sides) 78 and 80 of the anvil 30. This area that experiences a greater extent of wear can be considered to be a higher concentration wear portion (or a greater impingement portion) of the impingement surface. An insert that extends deeper into the body of the anvil will typically exhibit a longer useful life than an insert that does not extend as deep into the anvil body. The interior area of the impingement surface does not experience this greater degree of wear and can be considered to be a lower concentration wear portion (or a lesser impingement portion) of the impingement surface.

A typical wear pattern for such an anvil is shown in FIG. 4 wherein the right horizontal side (as viewed in the drawing) in worn in a generally arcuate fashion. The wear pattern is such so that the lower left hand portion of insert 42 is worn away, the outer portion of insert 50 is worn away, the outer portion of insert 58 is worn away to a greater extent than the wear of insert 50, insert 66 is essentially worn away and insert 74 has the upper right corner thereof worn away.

In the case of anvil 30, once it reaches a point where it no longer has a useful life, the anvil 30 can be rotated 180 degrees from a first position to a second position and then reused. This is the case for the worn anvil 30 of FIG. 4.

Referring to FIG. 4, the anvil 30 is shown in a worn condition wherein material that comprises the body 34 has been worn away from between the inserts. It should be appreciated that one kind of wear occurs in the horizontal direction (as viewed in FIG. 4), which is generally parallel to the direction of travel of aggregate when hurled against the anvil. Excessive horizontal wear can diminish the support of the body about the inserts, which can lead to the loss of the inserts during the rock crushing operation. Even though an anvil like that shown in FIG. 4 experiences wear, it still exhibits a useful life that is longer than an unreinforced anvil such as, for example, a white iron alloy anvil.

Anvil 30 (as worn) can be rotated 180 degrees and the substantially unworn impingement surface along the edge 78 now becomes the portion of the impingement surface that experiences the greater degree of wear. In this embodiment, the impingement surface along the right side of the anvil body could be considered to be a first portion of the impingement surface that experiences the wear when the anvil is in the first position in the crusher. The impingement surface along the left side of the anvil body could be considered to be a second portion of the impingement surface when the anvil is in the second position in he crusher.

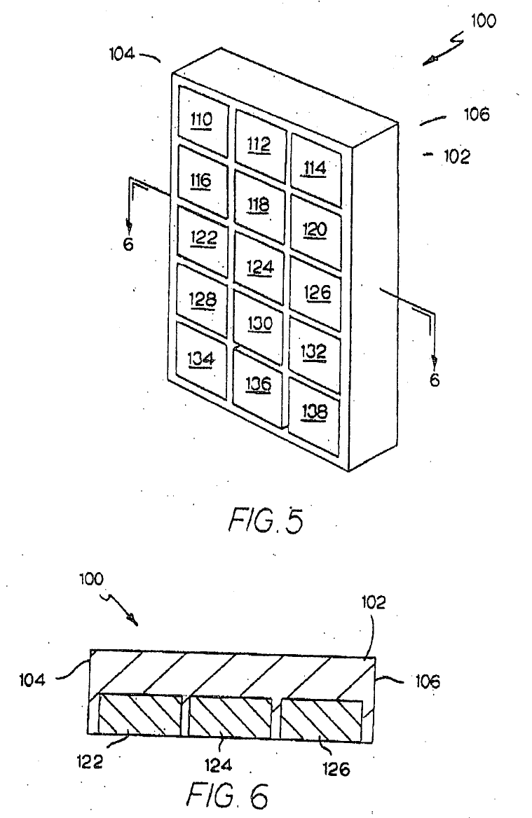

As mentioned hereinabove, another style of anvil 100, which is shown in FIGS. 5 and 6, uses a dove-tail type of connection on the rear surface of the anvil (not illustrated) to attach to the ring of the rock crusher body. Anvil 100 has a body 102 which presents opposite sides 104 and 106. Anvil 100 has a plurality of inserts 110 through 138. As shown by the cross-sectional view of FIG. 6, all of the inserts (122, 124, 126) in the middle horizontal row extend to substantially the same depth into the anvil body 102. This is also true for all of the other inserts of the anvil.

When this type of anvil 100 wears to a predetermined point, the rings are adjusted either vertically or horizontally in the rock crusher machine so as to expose another area of the anvil to impingement by the aggregate. For this kind of anvil 100, the tungsten carbide inserts are positioned at the different points of wear.

Referring to the (third) specific embodiment illustrated in FIGS. 7 through 10, there is illustrated an anvil generally designated as 120. Anvil 120 has a body 122 that has a left-hand (as viewed in FIG. 7) side or edge 124 and a right-hand side or edge 126 (as viewed in FIG. 7).

The anvil 120 contains a plurality of wear-resistant members (or inserts) that present a specific orientation that is designed to reduce the extent of wear of the face (or impingement surface) of the anvil 120, and thus, extend its useful life. Anvil 120 presents a left-hand vertical row of wear-resistant inserts (130, 138, 146, 154 and 162) and a right-hand vertical row of wear-resistant inserts (136, 144, 152, 160 and 168). The anvil 120 also has two vertical rows of interior wear-resistant inserts wherein one row comprises wear-resistant inserts 132, 140, 148, 156, 164 and 170, and the other vertical row comprises wear-resistant inserts 134, 142, 150, 158, 166 and 172.

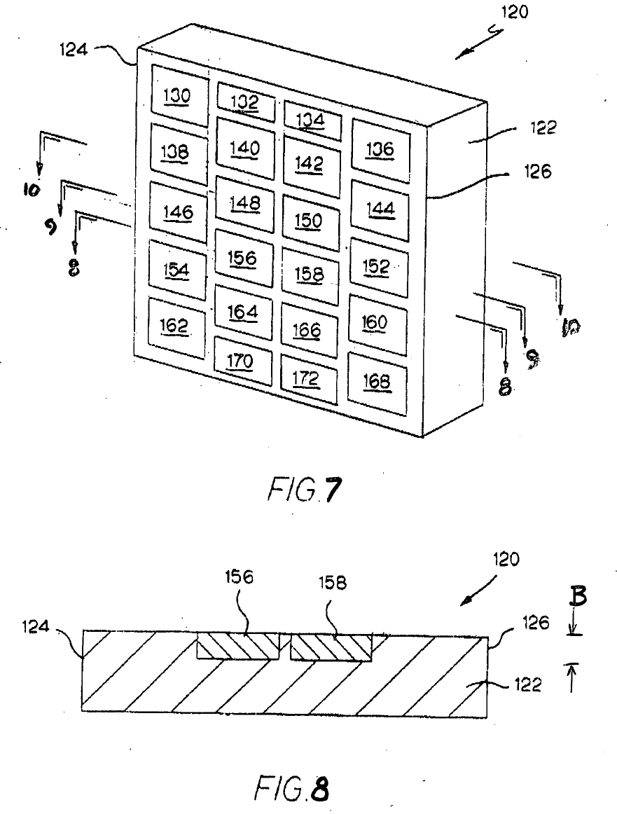

Generally speaking, the wear-resistant inserts that are in the interior of the anvil 120 do not extend as deep into the body 12 as do the wear-resistant inserts that are along the vertical edges (124, 126) of the anvil 120. The different depths that the wear-resistant inserts extend into the body 122 can be seen especially well by the cross-sectional views (FIGS. 8-10) taken along sections lines 8-8, 9-9 and 10-10 of FIG. 7, respectively.

FIG. 8 shows that the interior wear-resistant inserts 156 and 158 extend a depth “B” into the body 122 of the anvil 120. FIG. 8 also shows that these interior wear-resistant inserts 156 and 158 are not in horizontal alignment (as viewed in FIG. 7) with the adjacent exterior wear-resistant inserts 146, 154 and 152, 160. What this results in is an absence of a horizontal joint or gap (as viewed in FIG. 7) between the inserts that extends along the entire horizontal dimension of the anvil. Applicants will discuss this aspect of the anvil 120, which provides for improved wear-resistance properties, in more detail hereinafter.

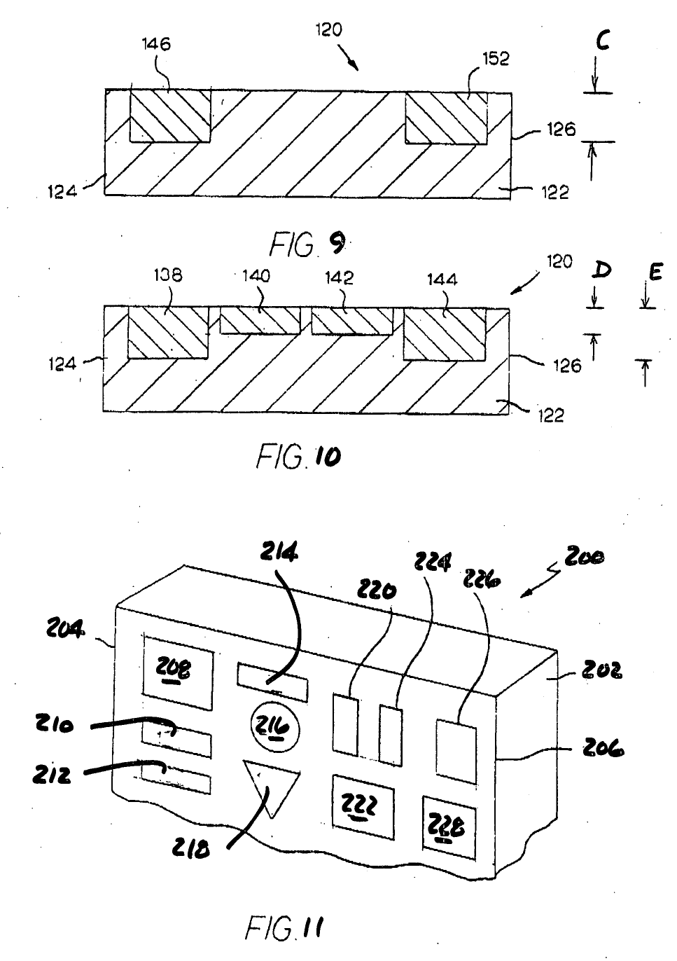

FIG. 9 shows that the exterior wear-resistant inserts 146 and 152, which are adjacent to the interior wear-resistant inserts 156 and 158 extend a depth “C” into the body 122 of the anvil 120. As is apparent from a comparison of FIGS. 8 and 9, the depth “B” is less than the depth “C”. The specific depths and the specific relationships between depths “B” and “C” can vary depending upon the specific application for the anvil. Further, applicants contemplate that inserts like inserts 146 and 152 that extend along the vertical edges of the anvil may each extend to a different depth into the body.

FIG. 10 shows a cross-sectional view that cuts through exterior wear-resistant inserts 138 and 144 and interior wear-resistant inserts 140 and 142. The exterior wear-resistant inserts 138 and 144 extend a depth “E” into the body 122 and the interior wear-resistant inserts 140 and 142 extend a depth “D” into the body 122. The distance “E” is greater than the distance “D”. The specific depths and the specific relationships between depths “D” and “E” can vary depending upon the specific application for the anvil 120. Further, applicants contemplate that these inserts may each extend to a different depth into the body; however, generally speaking, the inserts along the vertical edges will extend deeper into the body than the interior inserts.

Referring back to the orientation of the wear-resistant inserts on the face of the anvil 120, as previously mentioned, the orientation of the wear-resistant inserts is such that a horizontal joint or gap does not extend along the entire horizontal dimension of the anvil. In this regard, reference is made to horizontal axis A-A in FIG. 7 wherein it is apparent that the horizontal joint or gap between the inserts does not extend along the entire axis A-A.

Applicants have found that by positioning or orienting the wear-resistant inserts in such a fashion so as to eliminate a horizontal joint or gap (as viewed in FIG. 7) that extends along the entire horizontal dimension of the anvil, there is an increase in the wear resistance of the anvil, and hence, the useful life of the anvil 120. This is the case because there is the tendency for the body to wear at a greater rate than the wear-resistant inserts, which results in the wear of the body material between the wear-resistant inserts. This wear has the tendency to wear in the horizontal direction, which is generally parallel to the direction of movement of the aggregate when hurled against the anvil, if there is an absence of any interruption to the wear. Extensive wear in the gaps between the wear-resistant inserts will erode or weaken the support of the body about the wear-resistant insert which will lead to a loss of the insert during the crushing process.

By positioning the wear-resistant inserts in such a fashion as to eliminate a horizontal joint or gap (as viewed in FIG. 7) between the inserts that extends along the entire horizontal dimension of the anvil, the wear-resistant inserts present an interruption to the horizontal wear so that the horizontal wear cannot extend across the entire face of the anvil. The elimination of this form of horizontal wear increases the useful life of the anvil since it reduces or eliminates the loss of any wear-resistant inserts during the crushing process.

Referring to FIG. 11, there is illustrated still another specific embodiment of the anvil of the invention generally designated as 200. Anvil 200 comprises a body 202 that has a left-hand edge or side 204 and a right-hand edge or side 206. Anvil 200 presents a plurality of wear-resistant inserts that have a number of different orientations and/or geometries. It should be appreciated from the wide variation of wear-resistant insert styles and orientations such as those illustrated in FIG. 11 that the anvil of the present invention can be customized to fit a particular wear application or usage.

In reference to the wear-resistant inserts, there is a vertical row of inserts on the left-hand side of the anvil comprising inserts 208, 210 and 212. It can be appreciated that the exposed surfaces of these wear-resistant inserts take on different geometries in that the exposed surface of insert 208 is more of a square and the exposed surfaces of inserts 210 and 212 take on the shape of rectangles. There is a second vertical interior row of inserts that comprise wear-resistant insert 214 which has an exposed surface of a rectangular shape, wear-resistant insert 216 which has an exposed surface of a circular shape and insert 218 which has an exposed surface of a triangular shape. Three more interior wear-resistant inserts are to the right (as viewed in FIG. 11) of the second vertical row of the inserts, and these inserts comprise a pair of inserts 220 and 224 which an expose surface of a rectangular shape and a wear-resistant insert. 222 below these two inserts (220 and 224) which has an exposed surface of a square shape. Finally, the right-hand vertical row of the inserts comprises a pair of wear-resistant inserts 226 and 228, each of which has an exposed surface with a square geometry. Again, it should be appreciated from the wide variation of wear-resistant insert styles and orientations such as those illustrated in FIG. 11 that the anvil of the present invention can be customized to fit a particular wear application or usage.

The typical material that comprises the wear-resistant inserts in each one of the above embodiments is a cemented (cobalt) tungsten carbide. Specific compositions of the cemented (cobalt) tungsten carbide are set forth below. Other hard wear-resistant materials may also be suitable for use in the wear-resistant inserts as described below.

The typical composition for the cemented tungsten carbide inserts (or wear-resistant members) as used in these kinds of anvils (30 and 100) comprises, in its broader range, between about 5 weight percent and about 20 weight percent cobalt with the balance tungsten carbide (and trace amounts of impurities). A mediate range for the composition of the cemented tungsten carbide inserts is between about 5 weight percent and about 10 weight percent cobalt with the balance tungsten carbide (and trace amounts of impurities).

Applicants believe that two specific compositions of cemented tungsten carbide are preferred for the anvil. One composition comprises between about 7.5 weight percent and about 8.1 weight percent cobalt and the balance tungsten carbide (and trace amounts of impurities). The other composition comprises between about 5.7 weight percent and about 6.3 weight percent cobalt and the balance tungsten carbide (and trace amounts of impurities).

Applicants contemplate that others compositions of cemented carbides would be suitable for use in this anvil, as well as other hard material (e.g., ceramics such as alumina and zirconia or combinations thereof) would be suitable for use in this anvil. Specific applications may require specific compositions of materials for the insert to achieve optimum performance.

Applicants also contemplate that the composition of the wear-resistant inserts may vary in the anvil depending upon the specific application. For example, referring to the anvil 120 as illustrated in FIG. 7, the vertical row of wear-resistant inserts 130, 138, 146, 154 and 162 may be made from a grade (i.e., composition) of cemented (cobalt) tungsten carbide that is different from the grade of cemented (cobalt) tungsten carbide for the interior row of wear-resistant inserts (132, 140, 148, 156, 164 and 170). Applicants also contemplate that the grade for certain inserts in a specific vertical row may be different from the grade of other inserts in that same vertical row. For example, the grade of cemented (cobalt) tungsten carbide for insert 130 may be different than the grade of cemented (cobalt) tungsten carbide for insert 138.

Applicants further contemplate that the compositions of the wear-resistant insert may vary in that some inserts may be made of cemented (cobalt) tungsten carbide and some may be made of other wear-resistant materials such as other carbides or other cemented carbides or ceramics or cermets or the like.

In its broader aspects, applicants contemplate that any one of a wide variety of castable materials would be suitable for use as the body of the anvil. Of course, the castable material and the material of the wear-resistant member must be compatible.

One preferred composition for the body as used in these kinds of anvils comprises a steel having the following composition (in weight percent): 0.28-0.35 wt. % carbon; 1.5-2.0 wt % manganese; 1.3-1.7 wt % silicon; 0.08-0.15 wt % aluminum; 1.0-2.0 wt % nickel; 0.80-1.2 wt % chromium; 0.20-0.30 wt % molybdenum; and the balance iron and trace impurities. Applicants contemplate that others compositions of steel such as, for example, a high manganese steel (ASTM A128) which has a composition that typically ranges between about 1.0 weight percent and 1.4 weight percent carbon, between about 10 weight percent and about 14 weight percent manganese, and the balance iron and trace amounts of impurities. The white iron alloy (ASTM Specification A532 class III A alloy) referred to herein above, which has the composition of 2.3-3.0 weight percent carbon; 0.5-1.5 weight percent manganese; up to 1.0 weight percent silicon; up to 1.5 weight percent nickel; up to 1.5 weight percent molybdenum; 23-28 weight percent chromium, trace impurities and the balance iron, would also be a suitable steel for the body of the anvil.

It should be appreciated that specific applications may require specific compositions of materials for the alloy to achieve optimum performance. Thus, applicants do not intend to be limited to any specific composition for the wear-resistant member and for the body of the anvil.

It can thus be appreciated that applicants have invented a new and useful anvil for use in connection with an impact rock crusher machine. Applicants' anvil provides cast-in wear-resistant inserts in a steel body wherein these inserts provide for optimal wear protection.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the following claims.

What is claimed is:

1. An anvil for use in a crusher, the anvil comprising:
a body having an impingement surface, and the impingement surface having a high concentration wear area and a low concentration wear area;
a wear-resistant member; and
the high concentration wear area of the body having the wear-resistant member and the high concentration wear area of the body having a greater wear resistance than the low concentration wear area of the body.

2. The anvil of claim 1 wherein the wear-resistant member is a larger-sized wear resistant member, and further including a smaller-sized wear-resistant member, and the larger-sized wear-resistant member being in the high concentration wear area.

3. The anvil of claim 2 comprising a plurality of larger-sized wear-resistant members, and a plurality of the higher concentration wear portions, and each one of the high concentration wear area containing at least one of the larger-sized wear-resistant members.

4. The anvil of claim 2 wherein the smaller-sized wear-resistant member being in the low concentration wear area.

5. The anvil of claim 1 wherein the body comprises a castable material, and the body is cast around the wear-resistant member.

6. The anvil of claim 5 wherein the castable material is selected from the group consisting of steel, high manganese steels, white iron alloys and ceramics.

7. The anvil of claim 1 wherein the body contains a cavity, and the wear-resistant member being bonded to the body within the cavity.

8. The anvil of claim 1 wherein the wear-resistant member comprises cemented tungsten carbide, and the composition of the wear-resistant member comprising between about 5 weight percent an about 20 weight percent cobalt and the between about 80 weight percent and about 95 weight percent tungsten carbide.

9. The anvil of claim 8 wherein the cemented tungsten carbide comprises between about 5.7 weight percent and about 8.1 weight percent cobalt and between about 91.9 weight percent and about 94.3 weight percent tungsten carbide.

10. The anvil of claim 2 wherein the larger-sized wear-resistant member is of one composition and the smaller-sized wear-resistant member is of another composition.

11. The anvil of claim 1 wherein there being a plurality of wear-resistant members, and at least some of the wear-resistant members being of a different composition.

12. An anvil for use in a crusher, the anvil comprising:
a body having an impingement surface having a greater impingement portion that experiences a greater extent of impingement;
the body containing a plurality of wear-resistant members made from one or more wear-resistant materials; and
the greater impingement portion containing a higher concentration of the one or more wear-resistant material.

13. The anvil of claim 12 wherein the impingement surface further includes a lesser impingement portion, and the lesser impingement portion experiences a lesser extent of impingement, and the lesser impingement portion containing a lower concentration of the wear-resistant material.

14. The anvil of claim 12 wherein the wear-resistant member being made from at least two different wear resistant materials.

15. An anvil for use in a crusher wherein the anvil comprises:
a body having an impingement surface whereby aggregate impinges against the impingement surface, and the body being positionable between a first position and a second position;
a first portion of the impingement surface experiences a greater extent of impingement when the anvil is in the first position, and a second portion of the impingement surface experiences a greater extent of impingement when the anvil is in the second position;
the body containing wear-resistant material; and
the first portion of the impingement surface containing a higher concentration of the wear-resistant material, and the second portion of the impingement surface containing a higher concentration of the wear-resistant material.

16. The anvil of claim 15 wherein the impingement surface further including a third portion located mediate of the first portion and the second portion, and the third portion of the impingement surface containing a lower concentration of the wear-resistant material.
